(19) United States
(12) Patent Application Publication
(10) Pub. No.: US 2006/0238732 A1
(43) Pub. Date: Oct. 26, 2006

(54) High-NA unit-magnification projection optical system having a beamsplitter

(76) Inventor: Romeo I. Mercado, Fremont, CA (US)

Correspondence Address: Allston L. Jones;PETERS, VERNY, JONES,, SCHMITT & ASTON L.L.P., 425 Sherman Avenue, Suite 230, Palo Alto, CA, 94306-1850, US

(21) Appl. No.: 11/111,662

(22) Filed: Apr. 21, 2005

(51) Int. Cl. G03B 27/52

(52) U.S. Cl. 355/55; 355/52

(57) ABSTRACT

A high numerical-aperture (NA) unit-magnification projection optical system (10) is disclosed. The optical system includes along an optical axis (A1) a concave mirror (M), a lens group (G) and a beam splitter (20), which separates the object and image planes (OP, IP). The optical system can be corrected for an i-line spectral band, a g-h-i line spectral band or a deep ultraviolet (DUV) band centered at or near either 248 nm or 193 nm. Since the desired field shape is usually rectangular or square, selective vignetting of the full image-field diameter can be used to keep the size of the beam splitter reasonable even at high-NAs and relatively large image-field sizes.

### BACKGROUND OF THE INVENTION

1. Field of the Invention

The present invention relates to projection optical systems, and in particular to high numerical aperture (NA) unit-magnification projection optical systems for photolithographic applications.

2. Description of the Prior Art

Photolithography is presently employed not only in sub-micron resolution integrated circuit (IC) manufacturing, but also to an increasing degree in advanced-wafer level IC packaging technologies as well as in micro-mechanical systems (MEMS), nano-technology (i.e., forming nano-scale structures and devices), and other applications. These applications require multiple imaging capabilities ranging from relatively low resolution (i.e., a few microns) with a large depth of focus, to relatively high resolution (i.e., sub-micron) with a high throughput.

A unit-magnification imaging catadioptric optical system, consisting of a spherical mirror and a plano-convex lens, was described in a paper by J. Dyson, entitled “Unit Magnification Optical System Without Siedel Aberrations”, J. Opt. Soc. Am. 49(7), pp. 713-716 (1959). In this single-reflection optical system with the aperture stop at the mirror, the axial thickness of the piano-convex lens is equal to the radius of curvature of its convex surface. The lens is spaced apart from the mirror so that the centers of curvature of the spherical surfaces of the mirror and the lens are coincident and lie on the optical axis at the object and image planes. The radius of curvature of the mirror and the convex surface of the lens are chosen such that the Petzval sum of the optical system is zero. Such a concentric system is paraxially telescopic or telecentric in the object and image spaces. The image and object fields of this unit-magnification Dyson system are mutually inverted and lie on the rear plane surface of the lens. This system is well corrected for Seidel aberrations (i.e., no third-order monochromatic aberrations), but the lens contributes substantial higher-order aberration for off-axis field points as well as chromatic aberrations when used over an extended spectral range. The Dyson system has been used to image one half of the full image plane surface onto the other half. It has been used as a projection optical system for photolithography for small field, narrow-spectral-band exposure systems.

A modified Dyson system was described by C. G. Wynne in the articles “A Unit-power Telescope for Projection Copying”, Optical Instruments and Techniques, Oriel Press, Newcastle upon Tyne, England (1969), and “Monocentric Telescope for Microlithography”, Opt Eng. 26(4) 300-303 (1987). Wynne's modified Dyson system extended the optical performance of the Dyson system by using a doublet lens consisting of a monocentric negative meniscus element cemented to a plano-convex lens element. This unit-magnification Wynne-Dyson optical system provides very high aberration correction over an extended field of view at numerical apertures greater than 0.30 and over quite a wide spectral band. Correction from 546 nm to 405 nm is possible for a system designed to work in the visible spectrum where a wide range of optical glasses is available.

Like the Dyson system, the plane surface of the doublet lens of the Wynne-Dyson system is imaged inverted onto itself. In practice, the object is generally placed in one half of the object/image plane with the image appearing on the other half. Wynne described two practical methods of separating and transferring these object and image planes to more convenient positions. The first method is to convert part of the thick glass lens block into two identical folding prisms. This provides good access to both the object and image planes, but with a substantial reduction of available object/image field size. This method of field division was used on Wynne-Dyson type optical systems described in several U.S. patents, e.g., U.S. Pat. No. 4,391,494 by Hershel, U.S. Pat. No. 4,171,871 by Dill et al., and U.S. Pat. No. 4,103,989 by Rosin. The second method, which provides a larger imaging field area but with considerable loss of light, utilizes a beam splitter in the form of a glass block with a semi-reflecting surface at 45 degrees to the optical axis. The use of such a beam splitter enables the separation of the object and image planes without sacrificing the field size. The beam splitter method of separating the object and image surfaces was used on Dyson systems described in several U.S. patents (e.g., U.S. Pat. No. 4,171,870 by Bruning et al., U.S. Pat. No. 4,302,079 by White, U.S. Pat. No. 3,536,380 by Ferguson, and U.S. Pat. No. 2,231,378 by Becker et al.).

The Dyson system described by Bruning et al. in U.S. Pat. No. 4,171,870 comprises a concave spherical mirror, a piano-convex lens, a quarter-wave plate, and a beam splitter comprising two prisms, one of which is a roof prism. The system is such that the object and image have the same orientation and are positioned in two parallel planes for use as a compact “in-line” scanning projection printer. This unit-magnification system has a focal ratio of f/2 (NA=0.25) over the spectral band of 400-600 nm, and over 4 mm image field radius. The system has lens and prisms that may be made out of material having a refractive index of 1.7576 at 405 nm wavelength. The embodiment described has working distances (air spaces) of 0.2 mm at the object and image planes. The centers of curvatures of the spherical surfaces of the mirror and the lens are substantially coincident.

The Dyson system described by White in U.S. Pat. No. 4,302,079 comprises a thick piano-convex and a beam splitter adjacent the planar surface of the piano-convex lens. The beam splitter is made up of two right-angle prisms separated by a dielectric interface. The lens also includes an aspherical mirror located on the convex side of the plano-convex lens. Stress birefringence induced in the piano-convex lens is used to rotate the plane of polarization of the object radiation. This unit-magnification system has a focal ratio of f/2 (NA=0.25) and is optimized for the 215 nm wavelength and over a 14.2 mm field diameter. The lens and the beam splitter are made out of fused silica. The embodiment described has working distance of 1 mm and the system is substantially concentric.

The optical system described by Ferguson in U.S. Pat. No. 3,536,380 comprises a spherical mirror, a concave-convex (meniscus) lens, and a piano-convex lens. All the spherical surfaces of the system are concentric. A half-silvered plane mirror is located within the thick plano-convex lens and is disposed in a plane 45 degrees to the plane surface of lens. In the disclosed practical embodiment, the piano-convex lens is made out of material with a refractive index of 1.69 and the meniscus material has a refractive index of 1.75 without mentioning the wavelength. The optical system design is a Wynne-Dyson configuration.

Becker et al in U.S. Pat. No. 2,231,378 describe a unit magnification optical system with a beam-splitter-cube having a configuration somewhat similar to that of a Dyson system. This system has a bulky piano-convex element that extends in the immediate neighborhood of the concave spherical mirror. The convex lens surface and the mirror surface are concentric and separated by a small air gap. The optical system described by Becker et al. has two plano-concave field lenses, with one field lens cemented to the object side of the beam-splitter prism and the other field lens cemented to the image side of the beam-splitter prism.

### SUMMARY OF THE INVENTION

The present invention is an improvement of the above-described unit-magnification Dyson and Wynne-Dyson projection optical systems. The present invention enhances the utility of this well-known system for photolithography by providing design embodiments applicable to moderately high numerical aperture projection optical systems.

Example embodiments of the present invention provide designs for a moderately high numerical aperture (i.e., NA≧0.50) unit-magnification projection optical system with an image field diameter containing at least one 22 mm×22 mm step-and-repeat field, or one 34 mm×26 mm step-and-scan field. The present invention provides optical designs with essentially diffraction-limited imagery (e.g., Strehl ratios of 0.95 or greater) over a broad wavelength spectral band covering the g, h, and I spectral lines of mercury (436 nm, 405 nm and 365 nm). The design embodiments provide for multi-purpose utilization of the projection lens, such as photolithography in the I-line spectrum (e.g., 365 nm±10 nm, or more generally between about 350 nm and 390 nm) and photolithography in the g-h or g-h-I spectrum (e.g., from about 350 nm to about 450 nm). All the designs cover an exposure field size of 26 mm×34 mm, or at least a 22 mm×22 mm field.

In the discussion below, the “g-h-I spectral band” includes the g, h and I wavelengths of mercury (436 nm, 405 nm and 365 nm), and in an example embodiment extends from about 350 nm to about 450 nm. Also, the “I-line spectral band” includes the I-line wavelength of mercury of 365 nm, and in one example embodiment is 365 nm±10 nm while in another example embodiment extends from about 350 nm to about 390 nm. Further, the “deep ultraviolet (DUV) spectral band” generally means a spectral band centered around a wavelength of 300 nm or less. In example embodiments, the DUV spectral band is centered about 248 nm (e.g., 248 nm+/−0.5 nm) or is centered about 193 nm (e.g., 193 nm+/−0.5 nm).

A major obstacle for designing a broad spectral band projection lens system is the chromatic variation of aberrations over the wide wavelength spectral band for both the aperture-dependent and field-dependent aberrations. Aperture-dependent aberrations include spherical aberration, spherochromatism, and axial chromatic aberrations. The field-dependent aberrations include coma, astigmatism, Petzval or field curvature, distortion, and lateral color. For a Wynne-Dyson type of optical system, axial chromatic aberrations, spherochromatism (chromatic variation of spherical aberration), astigmatism, and the chromatic variation of astigmatism and field curvature are the main aberrations to correct or minimize for systems intended for broad-band applications. Since the Wynne-Dyson optical system is holosymmetric relative to an aperture stop located at the mirror element, coma, distortion, and lateral color are well-corrected.

One aspect of the invention provides for essentially diffraction-limited projection optical systems of moderately high numerical aperture (NA≧0.50) that are not only achromatic, but apochromatic over the I- and g-h-I spectral bands. These designs are also well-corrected for chromatic variations of both aperture-dependent and field-dependent aberrations. The optical designs provide for moderately high NA systems with optical parameters that can be scaled over a wide range of apertures and field diameters, while preserving essentially diffraction-limited performance. The system includes a beamsplitter (e.g., a beam-splitting cube) that forms separate object and image planes.

Another aspect of the invention provides for essentially diffraction-limited projection optical systems of moderately high numerical aperture (i.e., NA≧0.50) employing a unit-magnification Wynne-Dyson projection optical system with a beam splitting cube for use in DUV photolithography. Examples of DUV optical designs for a spectral band centered at about 193 nm are provided, though the designs can be extended to other spectral bands in the DUV, such as bands centered at 248 nm and 157 nm.

### BRIEF DESCRIPTION OF THE DRAWINGS

FIG. 1 is schematic cross-sectional diagram of an example embodiment of the projection optical system of the present invention, wherein the optical system includes a beam splitter, a three-element positive lens group and a concave mirror arranged in order along an optical axis;

FIG. 2 is a close-up view of the beam splitter and the three-element lens group of FIG. 1;

FIG. 3 is the plot of the variation in focus as a function of wavelength for the optical design embodiment set forth in Table 1 and shown in FIG. 1, showing apochromatic color-correction at three wavelengths in the g-h-I spectral band;

FIG. 4 is a plot of the variation in focus as a function of wavelength for the optical design embodiment set forth in Table 2 and shown in FIG. 1, showing apochromatic color-correction at three wavelengths in the g-h-I spectral band;

FIG. 5 is the plot of the variation in focus as a function of wavelength for the optical design embodiment set forth in Table 3 and shown in FIG. 1, showing apochromatic color-correction at three wavelengths over an extended spectral band that includes the I-line wavelength and a wavelength in the visible spectrum;

FIG. 6 is schematic cross-sectional diagram of an example embodiment of the projection optical system of the present invention, wherein the optical system includes a beam splitter and a single-element positive lens group;

FIG. 7 is schematic cross-sectional diagram of an example embodiment of the projection optical system of the present invention, wherein the optical system includes a beam splitter and a two-element lens group;

FIG. 8 is schematic close-up cross-sectional diagram of an example embodiment of the projection optical system of the present invention similar to that shown in FIG. 6, wherein the optical system includes a quarter-wave plate arranged between the beam splitter and the lens group;

FIG. 9 is schematic close-up cross-sectional diagram of an example embodiment of the projection optical system of the present invention similar to that shown in FIG. 7, wherein the optical system includes a quarter-wave plate arranged between the beam splitter and the lens group;

FIG. 10 is a schematic side view of a photolithography system that includes the projection optical system of the present invention; and

FIG. 11 is a plan view of a wafer showing an example array of exposure fields formed in the photoresist layer atop the wafer surface, wherein the exposure fields are formed by either a step-and-scan or step-and-repeat exposure using the photolithography system of FIG. 10.

The various elements depicted in the drawings are merely representational and are not necessarily drawn to scale. Certain proportions thereof may be exaggerated, while others may be minimized. The drawings are intended to illustrate various implementations of the invention, which can be understood and appropriately carried out by those of ordinary skill in the art.

### DETAILED DESCRIPTION OF THE INVENTION

The present invention improves and extends the utility of the unit-magnification Dyson or Wynne-Dyson projection optical system configuration. It is particularly applicable to moderately high NA (NA>0.50) photolithography in the DUV spectrum. Few optical materials exist that are suitable for refractive components in a projection optical system for DUV lithography applications. Examples of commonly used suitable refractive materials include fused silica for 248 nm and 193 nm applications, and calcium fluoride for 248 nm, 193 nm and 157 nm applications. The design of small field size, very high numerical aperture (NA≧0.8) Dyson or Wynne-Dyson systems is achievable using a half-field Dyson configuration. However, a very high NA design is not practical when the object and image planes are separated or transferred to more convenient locations using folding prisms or a beam splitter. The beam splitter option becomes impractical at high NAs because the space occupied by the beam splitter becomes an impractical constraint on the optical design.

### Embodiment with Three-element Lens Group

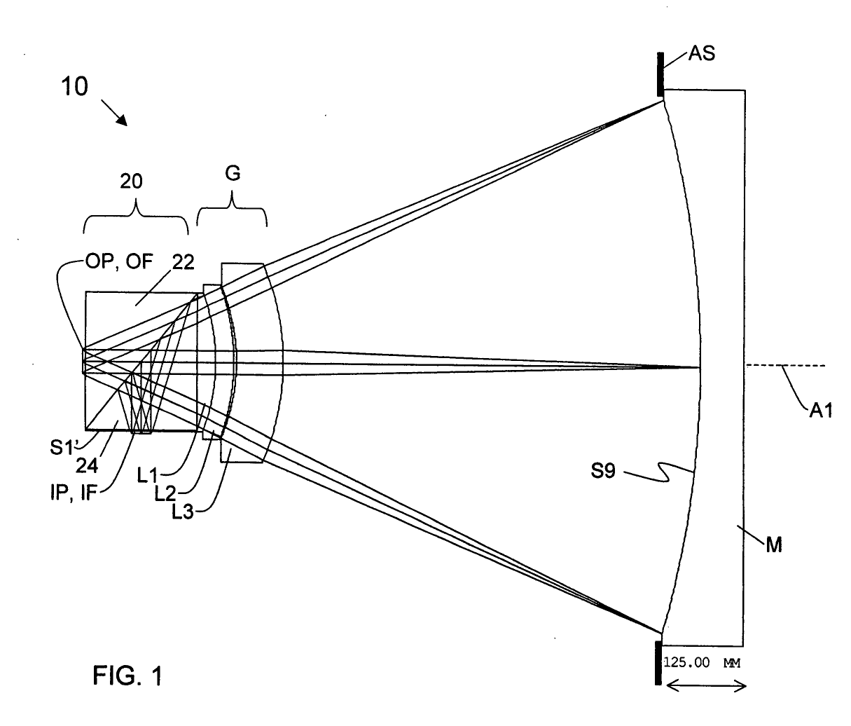

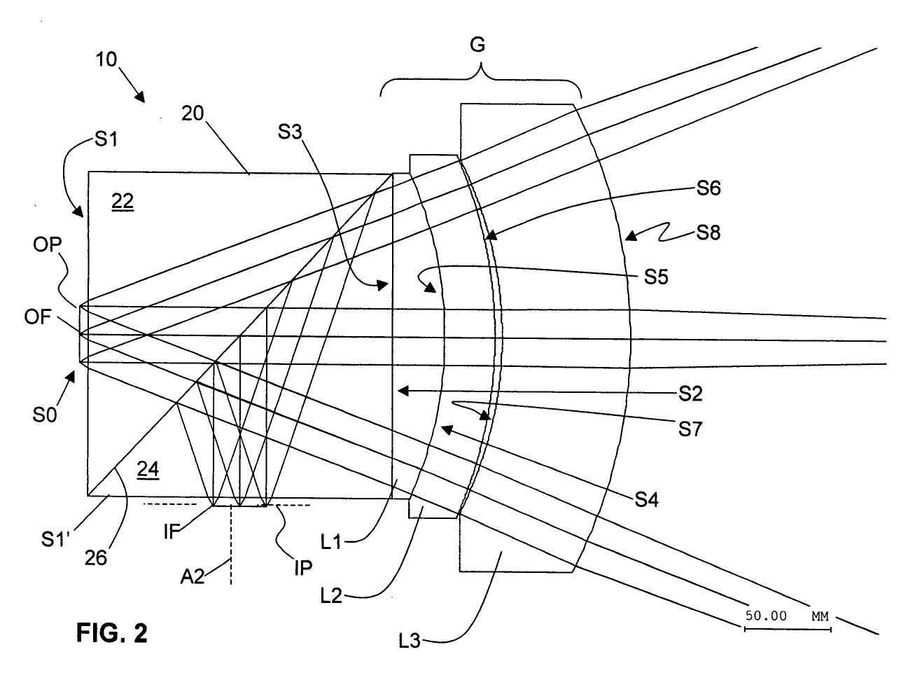

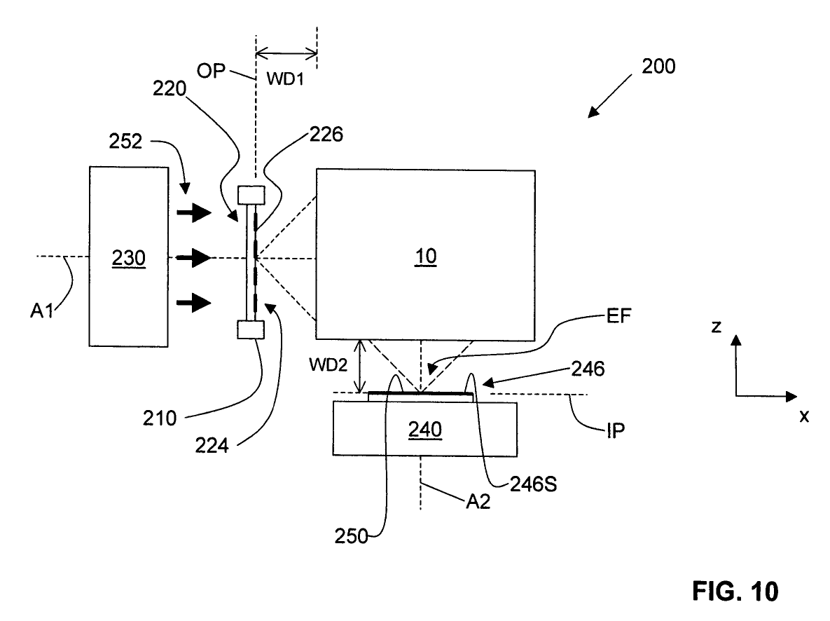

FIG. 1 is a cross-sectional diagram of an example embodiment of a unit-magnification projection optical system 10 according to the present invention. Optical system 10 includes an optical axis A1, in order along which is arranged (from left to right) a beamsplitter 20, a positive lens group G, and a concave mirror M. A variable aperture stop AS is located at mirror M. In the embodiment of FIG. 1, lens group G includes air-spaced lens elements L1, L2 and L3, FIG. 2 is a close-up view of beamsplitter 20 and lens group G. Beamsplitter 20 consists of two right angle prisms 22 and 24 interfaced at their hypotenuses to form a dielectric interface 26. Beamsplitter 20 creates a second optical axis A2 at right angles to optical axis A1 and that intersects optical axis A1 at the interface 26. Prism 22 includes a planar surface S1 at right-angles to axis A1 adjacent to which is an object plane OP that contains an object field OF. Object plane OP is spaced apart from planar surface S1 by a working distance WD1 (see FIG. 10). Likewise, prism 24 includes a planar surface S1′ at right angles to axis A2 adjacent to which is an image plane IP. Image plane IP is spaced apart from planar surface S1′ by a working distance WD2 (see FIG. 10). Optical system 20 is holosymmetric with respect to the aperture stop so that WD1=WD2. Prism 24 also includes a planar surface S2 that is at right angles to axis A1 (see FIG. 1) and opposite to planar surface S1 of prism 22, i.e., is immediately adjacent lens L1 of lens group G.

With reference to FIG. 2, in lens group G, lens L1 is a plano-convex lens having a planar surface S3 immediately adjacent planar face S2 of prism 24, and an opposing convex surface S4. Lens L2 is a meniscus lens with a concave surface S5 adjacent lens L1 and an opposing convex surface S6. Lens L3 is also a meniscus lens with a concave surface S7 adjacent lens L2 and an opposing convex surface S8. Mirror M is spaced apart from convex surface S8 and has a concave surface S9 (see FIG. 1).

The optical prescriptions for three design examples based on optical system 10 of FIGS. 1 and 2 are given in Tables 1-3 below. The three examples cover applications in the near UV, such as the portion of the spectrum encompassing the g-h-I wavelengths of mercury.

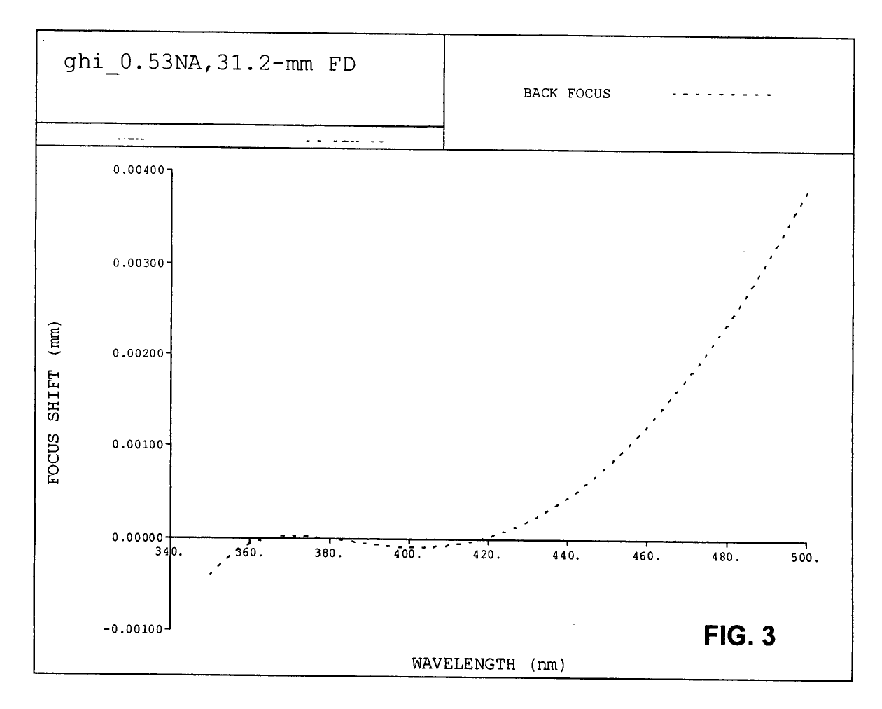

The optical prescription in Table 1 provides diffraction-limited performance over the broad-band g-h-I-spectrum of mercury at a NA≦0.53 and covering a field diameter of 31.6 mm enabling a 22 mm×22 mm square image field size for the NA=0.53 configuration. This 22 mm×22 mm image field size is normally designated as a standard “step-and repeat” field size. FIG. 3 is the plot of the variation in focus as a function of wavelength for the optical design embodiment in Table 1, showing apochromatic color-correction at three wavelengths in the g-h-I exposure band.

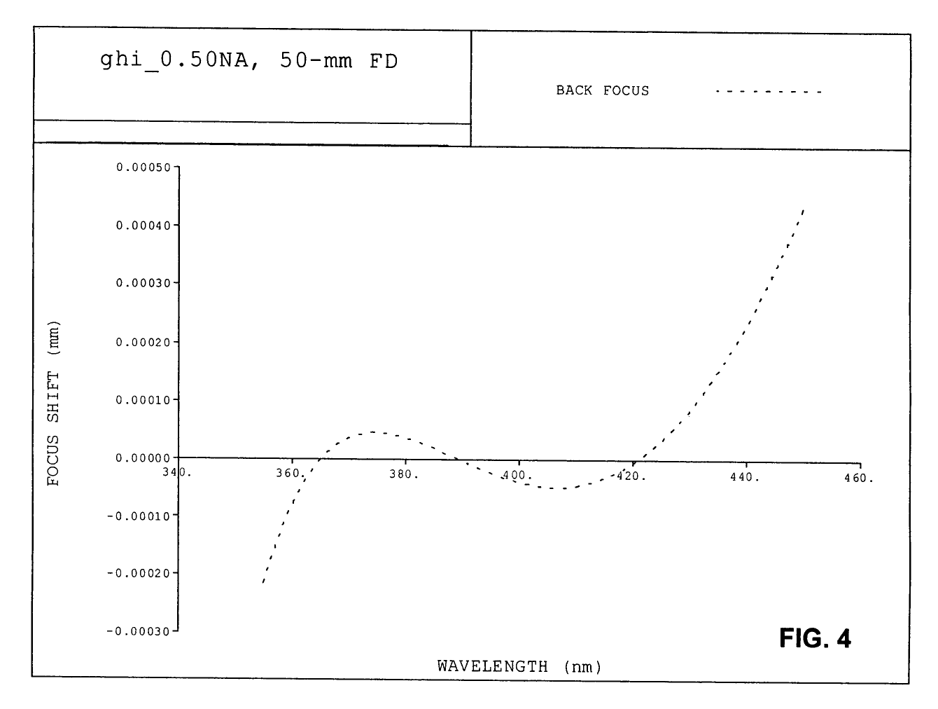

The optical prescription of Table 2 provides diffraction-limited performance over the broad g-h-I spectral band at a NA≦0.50 and covering an image field diameter of 50 mm, thereby enabling a 44 mm×22 mm rectangular image field size. The 44 mm by 22 mm rectangular image field size is equivalent to two, standard sized, step-and-repeat fields. Moreover, the 50 mm image field diameter of the embodiment in Table 2 easily holds a 34 mm by 26 mm image field. This particular field size is normally designated as a standard “step-and scan” exposure field size. FIG. 4 is a plot of the variation in focus as a function of wavelength for the optical design embodiment in Table 2, and shows apochromatic color-correction at three wavelengths in the g-h-I exposure band.

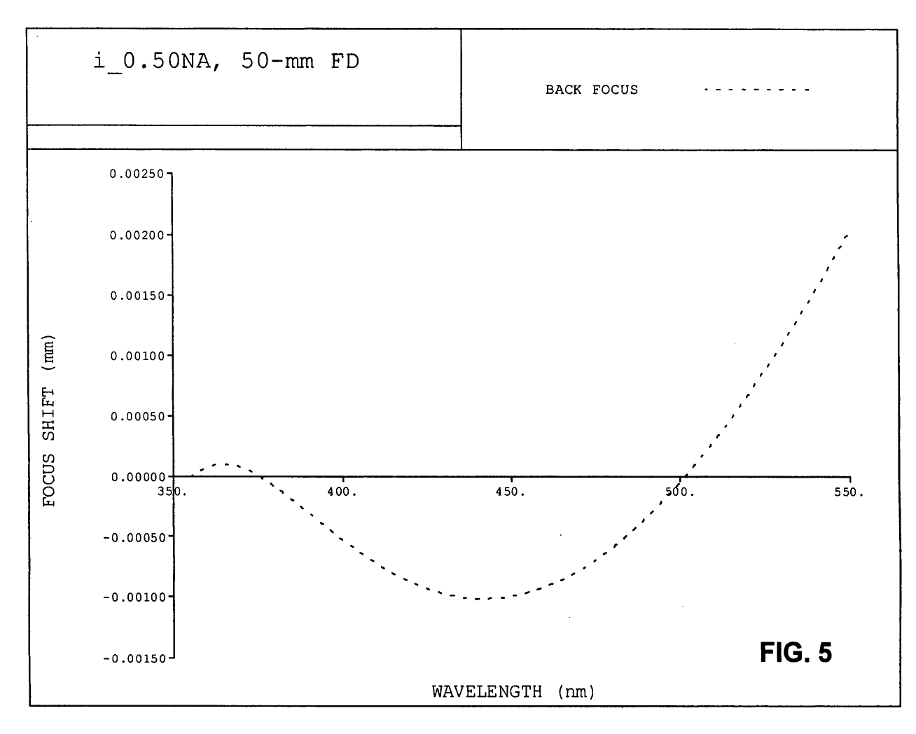

The optical prescription in Table 3 provides diffraction-limited performance over the narrow-band, I-line spectrum (i.e., 355 nm to 375 nm) at NA≦0.50. This projection optical system covers an image field diameter of 50 mm, sufficient to hold two step-and repeat fields, or one step-and-scan field. FIG. 5 is the plot of the variation in focus as a function of wavelength for the optical design embodiment set forth in Table 3, and shows apochromatic color-correction at three wavelengths over an extended spectral band that includes the I-line exposure spectrum, and a wavelength in the visible spectrum, the latter being potentially useful for alignment.

The design embodiments set forth in Tables 2 and 3 utilize the same glass materials for the refractive optical elements (i.e., the lens elements of lens group G and beam splitter 20) and also have the same specifications for the NA and image field diameter. The embodiment of Table 2 is apochromatic over the entire g-h-I exposure spectrum. The embodiment of Table 3 is achromatic over the I-line spectral band but apochromatic over the extended band pass encompassing the I-line exposure spectrum and a visible wavelength.

Each of the three embodiments set forth in Tables 1-3 provide a projection optical system capable of both low and high-resolution imaging by varying variable aperture stop AS. This extends the range of applications for optical system 10, from bump and packaging technologies for relatively low NAs, to mix-and match applications at higher NAs. The optical parameters in Tables 1-3 can be scaled over a wide range of apertures and field diameters, while preserving diffraction-limited performance over the indicated spectral band.

Embodiment with Single-element Lens Group

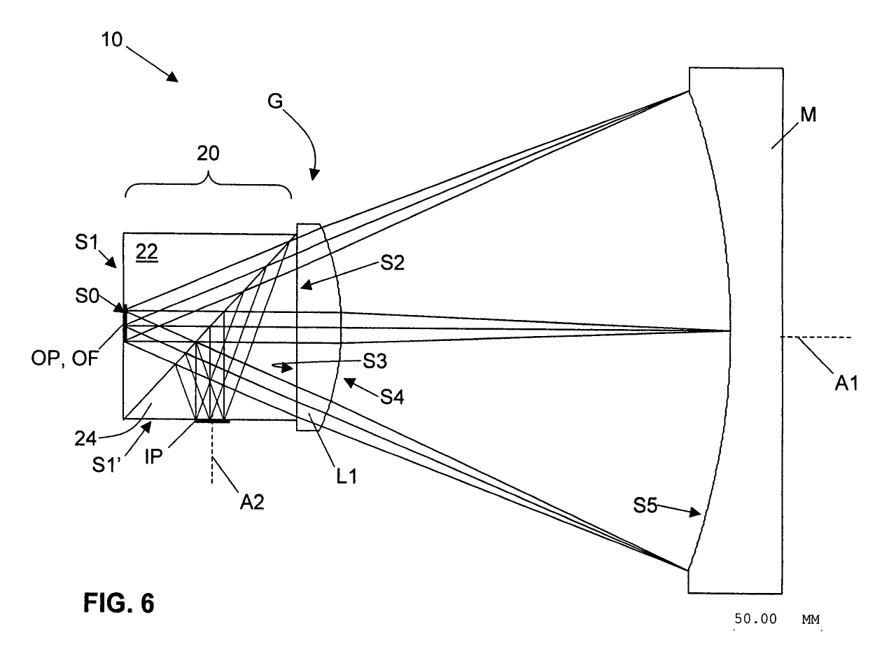

FIG. 6 is a cross-sectional diagram of another example embodiment of a unit-magnification projection optical system 10 according to the present invention similar to that of FIG. 1, wherein lens group G includes a single lens element in the form of plano-convex lens L1. An example embodiment of optical system 10 has a 16 mm field diameter, and NA=0.57 with diffraction-limited performance at a relatively narrow spectral band centered at 193.3 nm. Example optical prescriptions for optical system 10 are provided in Tables 4 and 5. Comparing the prescriptions in Table 4 and Table 5, the slight change in NA enables a 30% reduction in the beam splitter glass path (i.e., the size of beam splitter 20) for essentially the same field size and mirror radius. The thickness of the plano-convex lens L1 in Table 5 is at least two times that of the same plano-convex element in Table 4.

Embodiment with Two-element Lens Group

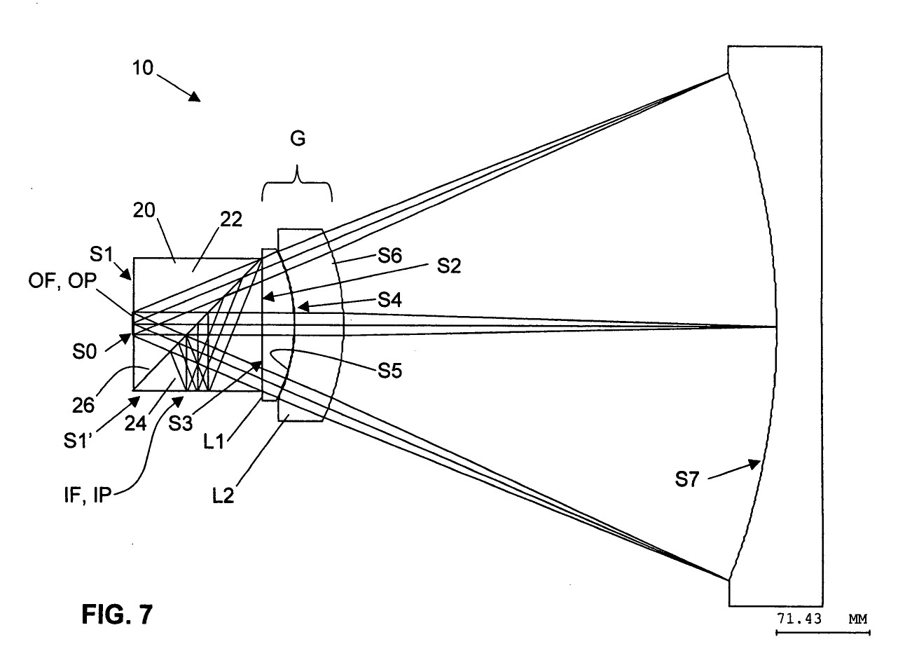

FIG. 7 is a cross-sectional diagram of another example embodiment of a unit-magnification projection optical system 10 similar that of FIG. 6, wherein lens group G consists of two lens elements L1 and L2, namely a plano-convex lens L1 and a meniscus lens L2. Projection optical system 10 of FIG. 7 has a 17 mm field diameter, and NA=0.57, with diffraction-limited performance at 193.3 nm. Table 6 sets forth an optical prescription for projection optical system 200. The optical design prescription of another example embodiment of optical system 200 is given in Table 7. The optical system in Table 7 has a NA of 0.54, a 17 mm image field diameter, and a 500 mm radius for mirror M. The 0.54-NA, beam splitter size in Table 7 is 20% smaller than that of the design set forth in Table 6. The thickness of the piano-convex lens L1 in Table 7 is approximately 44% less than that of the corresponding plano-convex element in Table 6. The meniscus lens element L2 in Table 7 is approximately 1.8 times thicker than that of the meniscus element in Table 6.

The above-described optical systems 10 have substantially concentric curved surfaces due to the limited choice of suitable refractive materials for DUV applications. The designs yield essentially diffraction-limited performance over the narrow bandwidth of an unnarrowed excimer laser. This is a much wider bandwidth than a typical reduction lens, which requires the laser bandwidth to be squeezed from 0.4 nm to about 0.002 nm.

The DUV design embodiments set forth herein are particularly well-suited for a projection lithography system (discussed below) with an illuminator adapted to illuminate the mask with an ArF excimer laser. At the ArF wavelength of 193.35 nm, the refractive index of fused silica is 1.560273 and for calcium fluoride is 1.501424. These refractive index values were used to generate the optical prescriptions for the example embodiments of Tables 6 and 7. The design configuration of the embodiments applies as well for applications at other DUV wavelengths. Accommodating different wavelengths requires the choice of appropriate materials for the refractive optical elements, and reoptimizing the imaging performance of the projection optical system at the new wavelength.

The variation in focus as function of wavelength was modeled for the DUV design embodiments. The design set forth in Table 4 has a linear focal variation of 0.04 micron over the spectral band, and the design set forth in Table 5 has a linear focal variation of 0.1 micron over the spectral band. The focus variation for the design set forth in Table 6 has three crossing points occurring between 193.4 nm to 193.8 nm, making this design apochromatic. The design set forth in Table 7 design has a linear focal shift variation of +0.08 micron over the spectral band of 193.0 nm to 193.8 nm. Note that the overall depth of focus is approximated by the equation:
˜2(λ/NA²)=(2)(0.193 microns)/(0.5)²˜1.5 microns

Thus, these DUV projection optical systems are well corrected for color over their relatively narrow spectral bands.

Embodiment with Polarizing Beam Splitter and Quarter-wave Plate

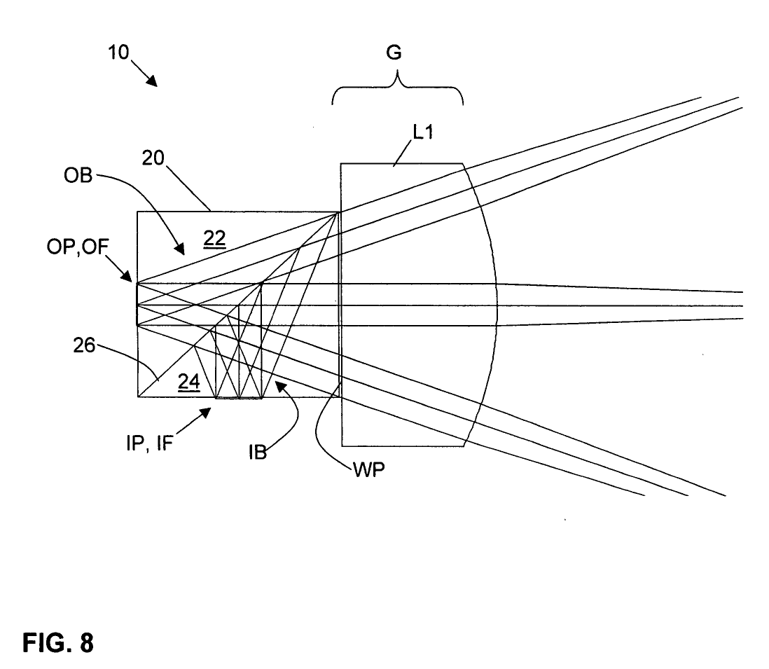

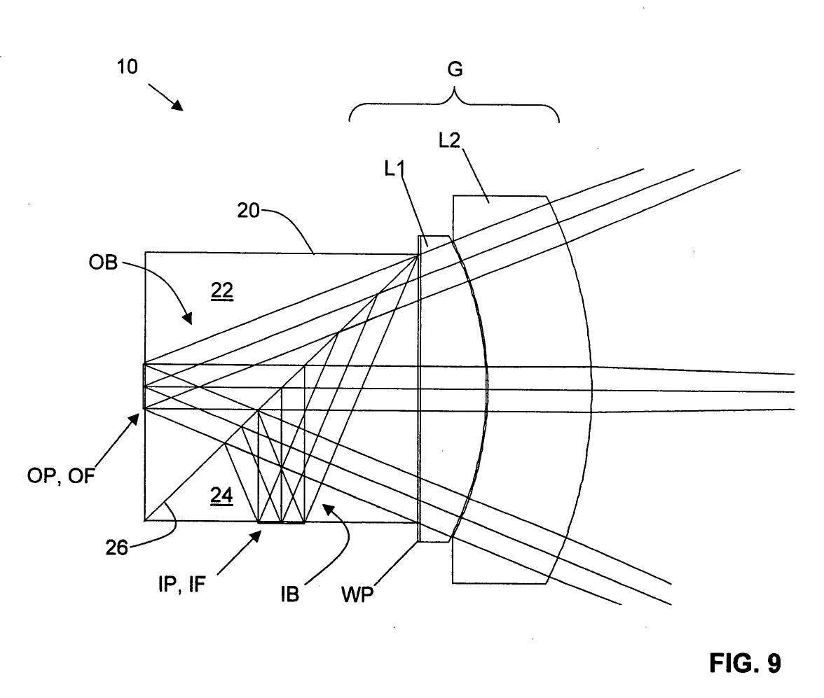

The transmission projection optical system of the present invention can be made relatively high if a polarizing beam splitter and a quarter wave plate are used in conjunction with linearly polarized light. Thus, in an example embodiment, a quarter wave plate WP is inserted in optical system 10 between beam splitter 20 and lens group G. In such a configuration, beam splitter 20 becomes a polarizing beam-splitter. This configuration is illustrated in the close-up schematic diagram FIG. 8 for the embodiment of optical system 10 of FIG. 6, and in the close-up schematic diagram of FIG. 9 for the embodiment of optical system 10 of FIG. 7.

In operation, quarter-wave plate WP converts an incident linearly polarized object beam OB into circularly polarized light incident to the mirror. After reflection from mirror M, the reflected light rays go through quarter-wave plate WP again and are further converted to an image beam IB of linearly polarized light having its plane of polarization rotated at 90 degrees from that of the original inputted object beam OB. Dielectric surface 26 of beam splitter 20 reflects and directs image beam IB to image plane IP. Quarter-wave plate WP may be constructed out of birefringent material such as crystalline quartz, depending on size and transmission requirements of the system.

When no naturally birefringent materials are available with suitable size and transmission properties, then the application of uniform compressive or tensile stress to induce sufficient birefringence in one of the elements of lens group G is an alternative method of providing the appropriate polarization rotation. A method of inducing birefringence by applying compressive stress in the piano-convex lens element of a Dyson system is disclosed by White in U.S. Pat. No. 4,302,079.

The optical prescriptions set forth in the Tables below may be scaled over a wide range of apertures and field diameters depending on the desired application. For example, when the prescriptions in Table 4 and Table 6 are scaled two times larger, the resulting systems provide diffraction-limited performance while enabling field diameters of 20 mm and 24 mm at NA≧0.60.

Beam Splitter Size

The manufacture of scaled projection optical systems according to the present invention is limited by the maximum practical size of beam splitter 20 and mirror M. However, the size of beam splitter 20 can be reduced if the shape of the desired image field IF permits vignetting of the equivalent circular image field. For example, consider a 22 mm×44 mm rectangular image field IF contained in a circular image field of 49.2 mm in diameter. With reference again to FIG. 2, a 49.2-mm diameter image/object field (IF/OF) implies that in this cross-sectional diagram, the dimensions of IF and OF are both 49.2 mm in size. A beam splitter 20 for supporting a circular field this large without vignetting is rather thick and bulky but will enable any other desired rectangular exposure field that fits within the 49.2-mm diameter circular field. However, if the 22 mm dimension is used to determine the beam splitter dimensions in the cross-section plane shown in FIG. 2, instead of the 49.2-mm diameter dimension, then the beam splitter size can be reduced substantially. Beam splitter 20 can be made arbitrarily large in the direction normal to the plane of FIG. 2 corresponding to the 44 mm field direction without impacting the beam splitter thickness in the plane of the diagram in FIG. 2. In this case, the optical design is vignetted with respect to the full field diameter of 49.2 mm, but not vignetted with respect to the desired field size of 22 mm×44 mm. A similar technique can be applied to reduce the size of the beam splitter and all of the other elements in the optical designs in Tables 2 and 3 if all that is required is a 26 mm×34 mm image field size.

Photolithography System

FIG. 10 is a schematic diagram of a photolithography system 200 that includes unit-magnification projection optical system 10 of the present invention as described above. System 200 includes along optical axis A1 a mask stage 210 adapted to support a mask (reticle) 220 with the top surface of mask (reticle) 220 at object plane OP. In an example embodiment, mask stage 210 is movable in object plane OP or in a plane parallel thereto. Mask 220 has a pattern 224 formed on a mask surface 226. An illuminator 230 is arranged adjacent mask stage 210 opposite optical system 10 and is adapted to illuminate mask 220 or a portion thereof.

System 200 also includes a wafer stage 240 adapted to support a wafer 246 with an upper surface 246S at image plane IP. In an example embodiment, wafer surface 246S is coated with a photosensitive layer 250 that is activated by one or more wavelengths of radiation 252 generated by illuminator 230. Such radiation is referred to in the art as “actinic radiation”. In example embodiments, radiation 252 is a spectral band containing a) the g-, h- and I-line wavelengths, b) the I-line wavelength, c) ˜248 nm, d) ˜193 nm or e) ˜157 nm.

Additionally, object plane OP is spaced apart from a first side of optical system 10 (planar surface S1 in FIG. 2) by a working distance WD1. Image plane IP is spaced apart from a second side of optical system 10 that is perpendicular to the first side (planar surface S1′ in FIG. 2) by a working distance WD2.

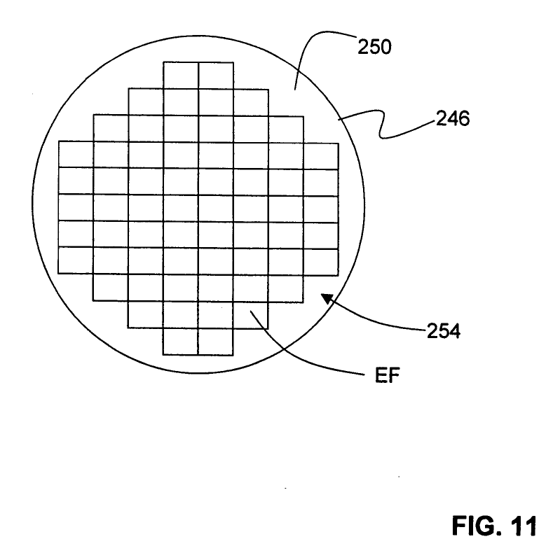

In an example embodiment, wafer stage 240 is movable in image plane IP or in a plane parallel thereto. With reference also to FIG. 11, in a step-and-repeat mode of operation, wafer stage 246 is stepped between exposures to form an array 254 of exposure fields EF in photoresist layer 250. In a step-and-scan mode of operation the motion of wafer stage 240 is synchronized With the motion of mask stage 210 to effectuate a scanned exposure of a portion of wafer 246. The wafer is then repositioned and synchronously scanned by moving wafer stage 240 synchronously with mask stage 210 to expose another portion or exposure field EF. This is repeated until a desired amount of the wafer (e.g., the entire wafer) is exposed.

In the step-and-repeat mode of operation, illuminator 230 illuminates mask 220 with radiation 252 of a select spectral band such as one of those listed immediately above. Stage 240 positions wafer 250 to align the image field IF with previously produced exposure fields EF (or to an alignment reference) so that pattern 224 is imaged at wafer 246 by optical system 10, thereby forming, after exposure, (another) exposure field EF in photoresist layer 250. Wafer stage 240 then moves (“steps”) wafer 246 in a given direction (e.g., the x-direction) by a given increment (e.g., the size of one exposure field EF), and the exposure process is repeated. This step-and-repeat exposure process is continued (hence the name “step-and-repeat”) until a desired number of step-and-repeat exposure fields EF (e.g., array 254) are formed on wafer 246.

In an alternate example embodiment, illuminator 230 illuminates a portion of mask 220 with radiation 252 having a select spectral band. Mask stage 210 is then scanned in a plane parallel to object plane OP while wafer stage 240 is synchronously scanned in a plane parallel to image plane IP. The result is a scanned exposure field EF. The wafer stage 240 then moves in a given increment and the scanning process is repeated until a desired number of “step-and-scan” exposure fields EF are formed on wafer 246.

Wafer 246 is then removed from system 200 (e.g., using a wafer handling system, not shown) and processed (e.g., developed, baked, etched, etc.) to transfer the patterns formed in photoresist 250 in each exposure field EF to the underlying layer(s) on the wafer. At this point, the resist is typically stripped, a new layer of material is added with a deposition process, and the wafer is again coated with resist. Repeating the photolithography process with different masks allows for three-dimensional structures to be formed in the wafer to create operational devices, such as ICs.

The example photolithography system 200 of FIG. 10 includes a transmissive mask 220 for the sake of illustration. The embodiments described, however, apply as well when mask 220 is a reflective reticle or when mask objects 224 are a reflective array of micro-mirrors. For such a mask, illuminator 210 is adapted to illuminate the reflective mask so that the reflective light is captured by projection optical system 10 and imaged onto wafer 246. A unit-magnification optical system with reflective reticle is disclosed in U.S. Pat. No. 5,040,882, which patent is incorporated by reference herein.

Lens Design Tables

Due to the symmetry of projection optical system 10 about aperture stop AS, the optical prescriptions in the Tables below include only values from the object plane OP to the concave mirror M.

In the Tables below, a positive radius indicates the center of curvature to the right of the surface, and negative radius indicates the center of curvature to the left when viewing the figures submitted herewith. The thickness is the axial distance to the next surface and all dimensions are in millimeters. Further, “S#” stands for surface number, “T or S” stands for “thickness or separation”, and “STOP” stands for aperture stop AS. Also, “CC” stands for “concave” and CX stands for “convex”. Further, under the heading “surface shape”, an aspheric surface is denoted by “ASP” a flat surface by “FLT” and a spherical surface by “SPH”.

Further, under the heading of “material”, both the glass name and the six-digit number using the internationally known and accepted convention for optical material designation are listed. For example, 516643 denotes BK7 glass and this designation implies that BK7 has a refractive index, N_{d}, of about 1.516 at the helium d-line wavelength, and an Abbe number of about 64.3 relative to the d-line and the C and F-lines of hydrogen. The Abbe number, V_{d}, is defined by the equation:
V_{d}=(N_{d}−1)/(N_{F}−N_{C})
where N_{F} and N_{C} are the refractive index values of the glass at the F and C lines.

The aspheric equation describing an aspherical surface is given by:

$$\begin{matrix}Z = \frac{( CURV ) {Y}^{2}}{1 + {( 1 - ( 1 + K ) {( CURV )}^{2} {Y}^{2} )}^{1 / 2}} + \\ ( A ) {Y}^{4} + ( B ) {Y}^{6} + {( C )}^{8} + ( D ) {Y}^{10} + ( E ) {Y}^{12}\end{matrix}$$

wherein “CURV” is the spherical curvature of the surface (the reciprocal of the radius of curvature of the surface), K is the conic constant, and A, B, C, D, and E are the aspheric coefficients. In the Tables, “E” denotes exponential notation (powers of 10). The design wavelengths represent wavelengths in the spectral band of the projection optical system.

TABLE 1

| | Image Field Diameter | Design Wavelengths |
|---|---|---|
| | (mm) | (nm) |
| NA = 0.53 | 31.6 | 436, 405, 365 |

| | SURFACE DESCRIPTION | | | | | ELEMENT |
|---|---|---|---|---|---|---|
| S # | RADIUS | | SHAPE | T or S | MATERIAL | DESCRIPTION |
| 0 | INF | | FLT | 0.0000 | | Working distance |
| 1 | INF | | FLT | 4.7619 | BAL15Y (557587) | WD |
| 2 | INF | | FLT | 180.0000 | | Beam splitter glass path |
| 3 | INF | | FLT | 0.0000 | SFSL5Y (487703) | L1 |
| 4 | −206.632 | CX | SPH | 30.7538 | | |
| 5 | −206.632 | CC | SPH | 0.0000 | PBL1Y (548458) | L2 |
| 6 | −225.750 | CX | ASP | 29.6009 | | |
| 7 | −198.625 | CC | ASP | 4.2874 | PBL25Y (581408) | L3 |
| 8 | −264.193 | CX | SPH | 75.4797 | | |
| 9 | −1009.624 | CC | ASP | 675.1163 | REFL(STOP) | Mirror M |

| S # | CURV | K | A | B | C | D |
|---|---|---|---|---|---|---|
| S6 | −0.00442969 | 0 | 7.34191e−9 | 2.31044e−13 | 8.80964e−18 | −1.95231e−22 |
| S7 | −0.00503461 | 0 | 6.83680e−9 | 2.37446e−13 | 9.65828e−18 | −5.16683e−23 |
| S9 | −0.00099047 | 0 | −7.67674e−13 | −3.25093e−18 | −2.86057e−24 | |

TABLE 2

| | Image Field Diameter | Design Wavelengths |
|---|---|---|
| | (mm) | (nm) |
| NA = 0.50 | 50.00 | 436, 405, 365 |

| | SURFACE DESCRIPTION | | | | | ELEMENT |
|---|---|---|---|---|---|---|
| S # | RADIUS | | SHAPE | T or S | MATERIAL | DESCRIPTION |
| 0 | INF | | FLT | 0.0000 | | Working distance |
| 1 | INF | | FLT | 3.8896 | BK7HT (516643) | WD |
| 2 | INF | | FLT | 200.0000 | | Beam splitter glass path |
| 3 | INF | | FLT | 0.0000 | FK5HT (487704) | L1 |
| 4 | −209.247 | CX | SPH | 36.000 | | |
| 5 | −209.247 | CC | SPH | 0.0000 | LLF1HT (548458) | L2 |
| 6 | −324.657 | CX | ASP | 48.5000 | | |
| 7 | −303.303 | CC | ASP | 2.5000 | LF5HT (591409) | L3 |
| 8 | −364.987 | CX | SPH | 110.0000 | | |
| 9 | −1307.538 | CC | ASP | 899.1104 | REFL(STOP) | Mirror M |

| S # | CURV | K | A | B | C | D |
|---|---|---|---|---|---|---|
| S6 | −0.00308017 | 0 | 3.00438e−9 | −4.91467e−15 | 1.91879e−18 | −2.13210e−23 |
| S7 | −0.00329704 | 0 | 2.66223e−9 | −1.51724e−15 | 1.75784e−18 | −1.53036e−23 |
| S9 | −0.00076480 | 0 | −3.17601e−13 | −2.95024e−19 | 3.87284e−25 | |

TABLE 3

| | Image Field Diameter | Design Wavelengths |
|---|---|---|
| | (mm) | (nm) |
| NA = 0.50 | 50.00 | 375, 365, 355 |

| | SURFACE DESCRIPTION | | | | | ELEMENT |
|---|---|---|---|---|---|---|
| S # | RADIUS | | SHAPE | T or S | MATERIAL | DESCRIPTION |
| 0 | INF | | FLT | 0.0000 | | Working distance |
| 1 | INF | | FLT | 4.8153 | BK7HT (516643) | WD |
| 2 | INF | | FLT | 200.0000 | | Beam splitter glass path |
| 3 | INF | | FLT | 0.0000 | FK5HT (487704) | L1 |
| 4 | −210.179 | CX | SPH | 36.0000 | | |
| 5 | −210.179 | CC | SPH | 0.0000 | LLF1HT (548458) | L2 |
| 6 | −336.115 | CX | ASP | 48.5000 | | |
| 7 | −315.651 | CC | ASP | 2.0000 | LF5HT (591409) | L3 |
| 8 | −369.350 | CX | SPH | 110.0000 | | |
| 9 | −1307.140 | CC | ASP | 898.6847 | REFL(STOP) | Mirror M |

| S # | CURV | K | A | B | C | D |
|---|---|---|---|---|---|---|
| S6 | −0.00297517 | 0 | 2.58133e−9 | −6.21658e−14 | 3.79969e−18 | −4.60272e−23 |
| S7 | −0.00316806 | 0 | 2.27543e−9 | −5.45210e−14 | 3.36053e−18 | −3.59514e−23 |
| S9 | −0.00076503 | 0 | −2.36434e−13 | −1.65587e−19 | 8.05920e−25 | |

TABLE 4

| | Image Field Diameter | Design Wavelengths |
|---|---|---|
| | (mm) | (nm) |
| NA = 0.57 | 16.00 | 193.4, 193.3, 193.2 |

| | SURFACE DESCRIPTION | | | | | ELEMENT |
|---|---|---|---|---|---|---|
| S # | RADIUS | | SHAPE | T or S | MATERIAL | DESCRIPTION |
| 0 | INF | | FLT | 0.0000 | | Working distance |
| 1 | INF | | FLT | 0.1641 | SIO2 | WD |
| 2 | INF | | FLT | 100.0000 | | Beam splitter glass path |
| 3 | INF | | FLT | 0.0000 | SIO2 | L1 |
| 4 | −126.017 | CX | SPH | 25.8000 | | |
| 5 | −350.114 | CC | ASP | 224.0359 | REFL (STOP) | Mirror M |

| S # | CURV | K | A | B | C | D | E |
|---|---|---|---|---|---|---|---|
| S5 | −0.00285622 | 0 | 4.77219e−12 | 8.67215e−17 | 1.33996e−21 | 1.49028e−26 | 6.12429e−31 |

TABLE 5

| | Image Field Diameter | Design Wavelengths |
|---|---|---|
| | (mm) | (nm) |
| NA = 0.55 | 16.00 | 193.4, 193.3, 193.2 |

| | SURFACE DESCRIPTION | | | | | ELEMENT |
|---|---|---|---|---|---|---|
| S # | RADIUS | | SHAPE | T or S | MATERIAL | DESCRIPTION |
| 0 | INF | | FLT | 0.0000 | | Working distance |
| 1 | INF | | FLT | 0.50 | SIO2 | WD |
| 2 | INF | | FLT | 70.0000 | | Beam splitter glass path |
| 3 | INF | | FLT | 0.0000 | SIO2 | L1 |
| 4 | −126.086 | CX | SPH | 55.3426 | | |
| 5 | −350.301 | CC | ASP | 224.1574 | REFL (STOP) | Mirror M |

| S # | CURV | K | A | B | C | D | E |
|---|---|---|---|---|---|---|---|
| S5 | −0.00285469 | 0 | 1.45083e−11 | 2.62965e−16 | 4.08397e−21 | 4.28699e−26 | 1.91719e−30 |

TABLE 6

| | Image Field Diameter | Design Wavelengths |
|---|---|---|
| | (mm) | (nm) |
| NA = 0.57 | 17.00 | 193.6, 193.4, 193.2 |

| | SURFACE DESCRIPTION | | | | | ELEMENT |
|---|---|---|---|---|---|---|
| S # | RADIUS | | SHAPE | T or S | MATERIAL | DESCRIPTION |
| 0 | INF | | FLT | 0.0000 | | Working distance |
| 1 | INF | | FLT | 0.7127 | Calcium Fluoride | WD |
| 2 | INF | | FLT | 100.0000 | | Beam splitter glass path |
| 3 | INF | | FLT | 0.0000 | Calcium Fluoride | L1 |
| 4 | −125.688 | CX | SPH | 25.0000 | | |
| 5 | −127.426 | CC | SPH | 0.5266 | Fused Silica | L2 |
| 6 | −166.399 | CX | SPH | 37.9756 | | |
| 7 | −500.000 | CC | ASP | 335.7851 | REFL (STOP) | Mirror M |

| S # | CURV | K | A | B | C | D | E |
|---|---|---|---|---|---|---|---|
| S7 | −0.00200000 | 0 | 3.98683e−12 | 3.37888e−17 | 2.70008e−22 | 4.37564e−28 | 3.31863e−32 |

TABLE 7

| | Image Field Diameter | Design Wavelengths |
|---|---|---|
| | (mm) | (nm) |
| NA = 0.54 | 17.00 | 193.6, 193.4, 193.2 |

| | SURFACE DESCRIPTION | | | | | ELEMENT |
|---|---|---|---|---|---|---|
| S # | RADIUS | | SHAPE | T or S | MATERIAL | DESCRIPTION |
| 0 | INF | | FLT | 0.0000 | | Working distance |
| 1 | INF | | FLT | 0.5000 | Calcium Fluoride | WD |
| 2 | INF | | FLT | 80.0000 | | Beam splitter glass path |
| 3 | INF | | FLT | 0.0000 | Calcium Fluoride | L1 |
| 4 | −95.250 | CX | SPH | 14.0330 | | |
| 5 | −98.286 | CC | SPH | 2.5864 | Fused Silica | L2 |
| 6 | −167.470 | CX | SPH | 69.1538 | | |
| 7 | −500.000 | CC | ASP | 333.7273 | REFL (STOP) | Mirror M |

| S # | CURV | K | A | B | C | D | E |
|---|---|---|---|---|---|---|---|
| S7 | −0.00200000 | 0 | 2.81784e−12 | 2.39783e−17 | 1.74643e−22 | 8.85316e−28 | 1.64252e−32 |

In the description herein, various features are grouped together in various example embodiments for ease of understanding. The many features and advantages of the present invention are apparent from the detailed specification, and, thus, it is intended by the appended claims to cover all such features and advantages of the described apparatus that follow the true spirit and scope of the invention. Furthermore, since numerous modifications and changes will readily occur to those of skill in the art, it is not desired to limit the invention to the exact construction and operation described herein. Accordingly, other embodiments are within the scope of the appended claims.

What is claimed is:

1. A unit-magnification projection optical system comprising along an optical axis:
a mirror with a concave surface;
an aperture stop located at the mirror that determines a numerical aperture (NA) of the system;
a lens group with positive refracting power arranged adjacent the mirror concave surface and spaced apart therefrom; and
a beam-splitter positioned adjacent the main lens group and opposite the mirror so as to form separate object and image planes;
wherein the system is corrected over a spectral band selected from the group of spectral bands comprising:
a) an i-line spectral band extending from about 350 nm to about 390 nm;
b) a g-h-i line spectral band extending from about 350 nm to about 450 nm;
c) a spectral band of about 248 nm+/−0.5 nm; and
d) a spectral band of about 193 nm+/−0.5 nm.

2. The projection optical system of claim 1, including two or three common foci within either the i-line spectral band or the g-h-i-line spectral band.

3. The projection optical system of claim 2, wherein the spectral band is either the i-line spectral band or the g-h-i-line spectral band, and wherein the system has an additional common focus outside of the spectral band.

4. The projection optical system of claim 1, wherein the concave mirror surface is aspherical.

5. The projection optical system of claim 1, wherein 0.5=NA=0.60.

6. The projection optical system of claim 1, wherein:
the spectral band is either the i-line spectral or the g-h-i-line spectral band; and
the beamsplitter consists of two interfaced prisms each formed from a glass type selected from the group of glass types comprising: 603606, 589612, 557587, and 516643.

7. The projection optical system of claim 1, wherein the aperture stop is variable.

8. The projection optical system of claim 1, wherein:
the spectral band is either the i-line spectral band or the g-h-i-line spectral band; and
the positive lens group consists of, in order towards the mirror: a piano-convex lens with a convex mirror-facing surface, a first meniscus lens having a mirror-facing convex surface, and a second meniscus lens spaced apart from the first meniscus lens and having a mirror-facing convex surface.

9. The projection optical system of claim 1, wherein:
the spectral band is either the 248 nm+/−0.5 nm spectral band or the 193 nm+/−0.5 nm spectral band; and
the lens group consists of a single piano-convex lens having a convex mirror-wise surface.

10. The projection optical system of claim 1, wherein:
the spectral band is either the 248 nm+/−0.5 nm spectral band or the 193 nm+/−0.5 nm spectral band; and
the lens group consists of, in order towards the mirror: a plano-convex lens with a convex mirror-facing surface, and first meniscus lens having a mirror-facing convex surface.

11. A unit-magnification projection optical system comprising along an optical axis:
a mirror with a concave surface;
an aperture stop located at the mirror that determines a numerical aperture (NA) of the system;
a lens group with positive refracting power arranged adjacent the mirror concave surface and spaced apart therefrom, the lens group having at least one piano-convex lens element;
a beam-splitter positioned adjacent the lens group and opposite the mirror so as to form separate object and image planes; and
two or three common foci over either an i-line spectral band or a g-h-i-line spectral band.

12. The projection optical system of claim 11, wherein the spectral band is the g-h-i-line spectral band, and wherein the projection optical system has one of:
a) a 22 mm×22 mm image field at a NA of 0.53;
b) a 34 mm×26 mm image field at a NA of 0.50; and
c) at least two 22 mm×22 mm step-and-repeat fields at a NA of 0.50.

13. The projection optical system of claim 11, wherein the spectral band is the i-line spectral band, and wherein the projection optical system has one of:
a) at least one 34 mm×26 mm step-and-scan image field at a NA of 0.50; and
b) at least two 22 mm×22 mm step-and-repeat image fields at a NA of 0.50.

14. A unit-magnification projection optical system comprising along an optical axis:
a mirror with a concave surface;
an aperture stop located at the mirror that determines a numerical aperture (NA) of the system;
a lens group with positive refracting power arranged adjacent the mirror concave surface and spaced apart therefrom, the lens group having at least one plano-convex lens element;
a beam-splitter positioned adjacent the lens group and opposite the mirror so as to form separate object and image planes; and
a spectral band selected from the group of spectral bands consisting of: a first deep ultra-violet (DUV) spectral band of about 248 nm+/−0.5 nm and a second DUV spectral band of about 193 nm+/−0.5 nm.

15. The projection optical system of claim 14, wherein the plano-convex lens element is formed from calcium fluoride.

16. The projection optical system of claim 14, wherein the lens group includes a fused silica meniscus lens element having a concave surface arranged adjacent the convex surface of the plano-convex lens element.

17. The projection optical system of claim 14, having an image field of at least 17 mm in diameter at a numerical aperture of at least 0.57 for the second DUV spectral band.

18. The projection optical system of claim 14, wherein:
the beam splitter is a polarizing beam splitter made of calcium fluoride;
wherein the optical system further includes a quarter wave plate arranged between the beam splitter and the piano-convex lens element.

19. A projection lithography system comprising:
a unit-magnification projection optical system comprising along an optical axis:
a mirror with a concave surface;
an aperture stop located at the mirror that determines a numerical aperture (NA) of the system;
a lens group with positive refracting power arranged adjacent the mirror concave surface and spaced apart therefrom; and
a beam-splitter positioned adjacent the main lens group and opposite the mirror so as to form separate object and image planes;
wherein the system is corrected over a spectral band selected from the group of spectral bands comprising:
a) an i-line spectral band extending from about 350 nm to about 390 nm;
b) a g-h-i line spectral band extending from about 350 nm to about 450 nm;
c) a spectral band of about 248 nm+/−0.5 nm; and
d) a spectral band of about 193 nm+/−0.5 nm;
a mask stage capable of supporting a mask at the object plane;
an illuminator adapted to illuminate the mask with radiation having wavelengths in the spectral band; and
a wafer stage capable of movably supporting a wafer at the image plane.

20. The projection lithography system of claim 19, wherein the mask stage is adapted to move in synchrony with the wafer stage so as to form a scanned exposure field on the wafer.

21. A projection lithography system comprising:
a unit-magnification projection optical system comprising along an optical axis:
a mirror with a concave surface;
an aperture stop located at the mirror that determines a numerical aperture (NA) of the system;
a lens group with positive refracting power arranged adjacent the mirror concave surface and spaced apart therefrom, the lens group having at least one plano-convex lens element;
a beam-splitter positioned adjacent the lens group and opposite the mirror so as to form separate object and image planes; and
a spectral band selected from the group of spectral bands consisting of: a first deep ultra-violet (DUV) spectral band of about 248 nm+/−0.5 nm and a second DUV spectral band of about 193 nm+/−0.5 nm;
a mask stage capable of supporting a mask at the object plane;
an illuminator adapted to illuminate the mask with radiation having wavelengths in the spectral band; and
a wafer stage capable of movably supporting a wafer at the image plane.

22. The projection lithography system of claim 21, wherein the mask stage is adapted to move in synchrony with the wafer stage so as to form a scanned exposure field on the wafer.
